(19) United States
(12) Patent Application Publication
(10) Pub. No.: US 2008/0046724 A1
(43) Pub. Date: Feb. 21, 2008

(54) Method for governing interaction between code within a code base

(75) Inventor: Conan B. Dailey, Scottsdale, AZ (US)

Correspondence Address: MESCHKOW & GRESHAM, P.L.C., 5727 NORTH SEVENTH STREET, SUITE 409, PHOENIX, AZ, 85014, US

(73) Assignee: GENERAL DYNAMICS C4 SYSTEM, INC., Scottsdale, AZ (US)

(21) Appl. No.: 11/493,397

(22) Filed: Jul. 25, 2006

(51) Int. Cl. H04L 9/00

(52) U.S. Cl. 713/164

(57) ABSTRACT

A separation management system (32) for governing interaction between code within a code base (50) operable on a computer (30) determines a region in a memory (44) of the computer (30) in which the code base (50) resides and defines container boundaries (118, 124, 130, 135) in the region for a plurality of containers (95). Each of the containers (95) contains subsets of the code (120, 126, 132, 137) that cannot be trusted. A policy (94) is created that governs interaction between the subsets of the code in the containers (95). The code base (50) is executed in the computer (30) in accordance with the policy (94) such that the subsets of code within the containers (95) are prevented from accessing code outside of their respective containers (95) when access is disallowable as indicated by the policy (94).

### TECHNICAL FIELD OF THE INVENTION

The present invention relates to the field of computing systems. More specifically, the present invention relates to governing interaction between code within an within a code base, such as an operating system environment.

### BACKGROUND OF THE INVENTION

A computing system typically relies on a set of instructions which defines an operating system (OS) in order to manage the hardware and software resources of the computing system. The OS performs basic tasks, such as controlling and allocating memory, prioritizing the processing of instructions, controlling input and output devices, facilitating networking, managing files, and so forth.

The lowest level of any operating system is its kernel. This is the first layer of software loaded into memory when a system boots or starts up. The kernel level provides access to various common core services to all other system and application programs. These services include, but are not limited to, disk access, memory management, task scheduling, and access to other hardware devices.

An operating system typically consists of a code base of many code modules (both OS vendor code and third party code) linked together in one address space to form a single binary program that runs in the kernel mode or level. Indeed, the operating system vendors have increasingly integrated greater amounts of third party code modules, such as device drivers, into their OS code bases. Much of this code operates at the most privileged level, i.e., the kernel level, in the processor. Linking all of the modules together in a single address space, sometimes referred to as a monolithic kernel, generally yields better performance in terms of hardware access and is easier to design and implement than other OS solutions.

Mechanisms are typically employed that enable the kernel to defend itself against crashes due to user-mode software processes. These various mechanisms include, for example, the use of a memory management unit and privileged and non-privileged modes of operation. While use of these mechanisms has been widely leveraged by operating system vendors to isolate application code, their use through the code base of the operating system itself has been more limited. Whether due to complexity, performance, or legacy concerns, the vendors have not extended the notion of process isolation strongly to their OS code base.

FIG. 1 shows an illustrative diagram of a conventional operating system kernel 20. Kernel 20 includes a plurality of code modules, shown as device drivers 22, some that are trusted and some that are untrusted. Although only device drivers 22 are shown, those skilled in the art will readily appreciate that kernel 20 can also include interrupt handlers, a scheduler, interprocess communication, network code, and so forth. Operating system 20 further includes OS security critical data 24. Unfortunately, malicious code 26 has become part of one of device drivers 22, labeled untrusted device driver C. Malicious code 26 is able to access and modify OS security critical data 24 because device driver 22, i.e., untrusted device driver C, has full access to all OS kernel state.

Without the protection of process isolation, the entire operating system 20 is left open to modification and subversion if any code, such as malicious code 26, is able to run with the same privileges as the kernel itself. That is, any programming errors (bugs) or malicious code in any code module operating at the kernel level can readily destroy operating system critical data structures in an unrelated module and cause an operating system to crash. Of particular concern are the programming errors and malicious code that may be present in this third party code operating at the kernel level because such third party code often escapes rigorous testing. Thus, buggy third party code, such as a device driver, can corrupt kernel tables and cause an operating system to crash.

Ironically, although untrusted third party code, generally device drivers, operating at the kernel level is most likely to cause operating system problems, this third party code typically requires little interaction with the OS. Therefore, it does not need to operate at such a privileged level.

Attempts have been made to circumvent this problem through the implementation of a microkernel or minimal kernel architecture. The microkernel approach defines a simple abstraction over the hardware, with a set of primitives or system calls to implement minimal OS services such as address space management, thread management, and inter-process communication. All other servers, including those normally provided by the kernel such as networking, are implemented in user-space programs referred to as servers. Microkernels are easier to maintain than monolithic kernels, and a bug in third party code is less likely to crash the system because the servers are running apart from the main thread. Unfortunately, they generally underperform relative to traditional monolithic designs. This underperformance is due in large part to the overhead of moving in and out of the kernel, a context switch, in order to move data between the various applications and servers.

Accordingly, what is needed is a technique for providing process isolation within a code base, such as within an operating system, that does not adversely affect the performance of the operating system.

### SUMMARY OF THE INVENTION

Accordingly, it is an advantage of the present invention that a method and system are provided for governing interaction between code within a code base.

It is another advantage of the present invention that a method and system are provided for enabling process separation in a code base of an operating system that does not adversely affect the performance of the operating system.

Another advantage of the present invention is that a method and system are provided that enable process separation between code within a code base of an operating system without requiring modification to the operating system.

The above and other advantages of the present invention are carried out in one form by a method for governing interaction between code within a code base operable on a computer. The method calls for determining a region in a memory of the computer in which the code base resides and defining container boundaries in the region for a plurality of containers, the containers containing subsets of the code. A policy is created that governs said interaction between the subsets of the code contained in the containers and the code base is executed on the computer in accordance with the policy.

The above and other advantages of the present invention are carried out in another form by a computer-implemented separation management system executable in connection with an operating system of a computer for governing interaction between code within a code base of the operating system. The system includes a plurality of containers established in a region of a memory of the computer in which the code base resides. The containers are defined by container boundaries, and the containers contain subsets of the code within the code base, the subsets of the code being untrusted code within the operating system. The system further includes a policy that governs interaction between the subsets of the code contained in the containers. A policy manager is executed in connection with said operating system on the computer. The policy manager utilizes the policy to govern interaction between the subsets of the code.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows an illustrative diagram of a conventional operating system kernel;

FIG. 2 shows a block diagram of a computing system that incorporates a separation management system in accordance with a preferred embodiment of the present invention;

FIG. 3 shows a block diagram of the separation management system;

FIG. 4 shows a flowchart of an overlay management process;

FIG. 5 shows a table representing a container database defined in connection with execution of the overlay management process of FIG. 4;

FIG. 6 shows a table representing a separation policy created in connection with the execution of the overlay management process of FIG. 4;

FIG. 7 shows a flowchart of a security enforcement process;

FIG. 8 shows an illustrative diagram of an operating system kernel in which the separation management system has been implemented; and

FIG. 9 shows a flowchart of privileged memory control process.

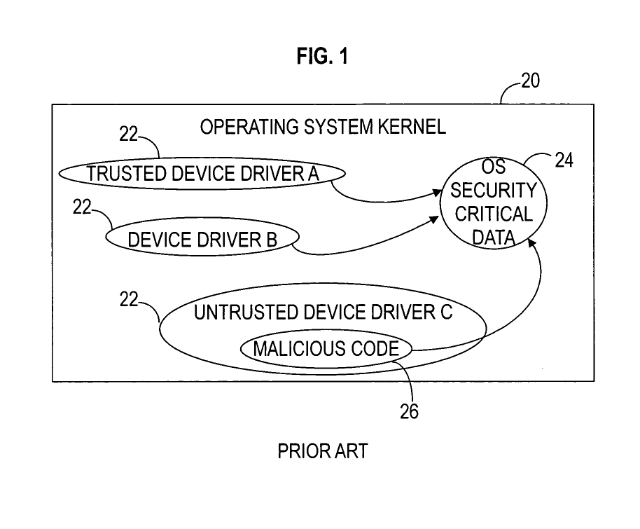

### DETAILED DESCRIPTION OF THE PREFERRED EMBODIMENTS

The present invention generally relates to governing interaction between code within a code base operable on a computer. The present invention non-intrusively separates the code within an existing code base to protect the code from one another, without modification to the existing code base.

The present invention is described in connection with governing interaction of code within a code base of an operating system. The present invention may be particularly implemented in connection with the OS kernel, the most privileged level in a processor, to isolate those processes that operate in the kernel level, but typically require little interaction with the OS. However, it should be understood that the term “code base” is not limited to the source code that makes up an operating system, but can further, or alternatively, include the larger collection of all the code of all the computer programs and processes operable on a computer.

The present invention employs the “principle of minimal privilege,” also known as “principle of least privilege” or just “least privilege.” In computing, the basic tenet of least privilege is to grant the minimum possible privileges to permit a legitimate process to see and use only such information and resources that are necessary to perform its function. Least privilege thus can enhance protection of data and functionality from faults and malicious behavior. The present invention employs the principle of least privilege as an overlay to an underlying code base to govern interaction between code in the code base and provide process separation.

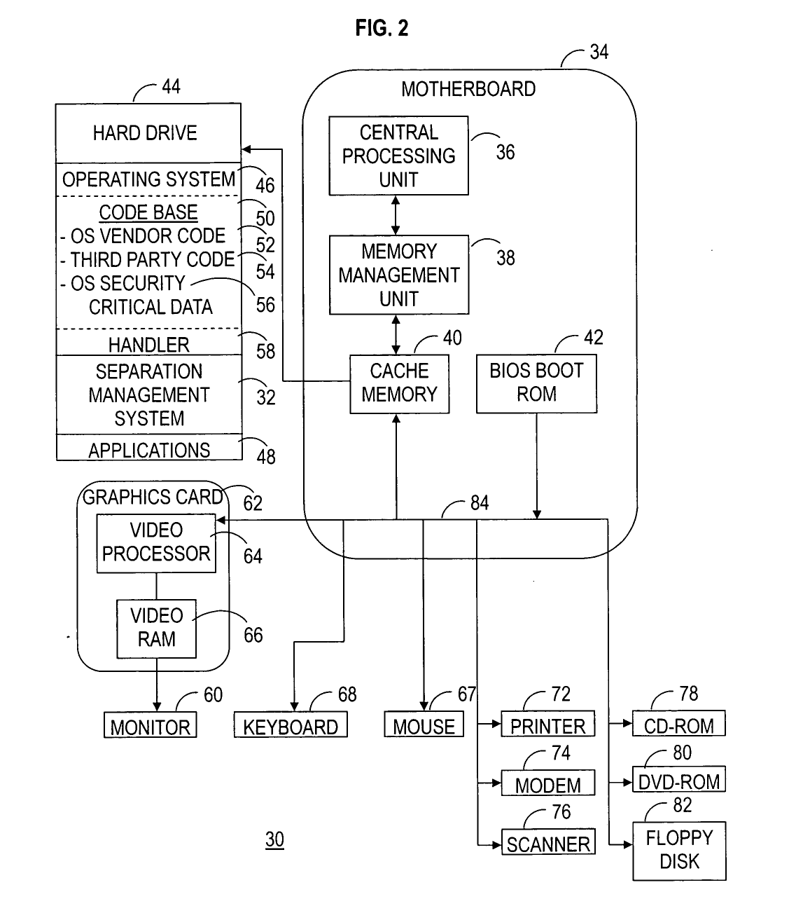

FIG. 2 shows a block diagram of a computing system 30 that incorporates a separation management system 32 in accordance with a preferred embodiment of the present invention. Computing system 30 generally includes a motherboard 34 populated with appropriate integrated circuits including, for example, one or more processing units 36, a memory management unit (MMU) 38, and memory, a portion of which is represented herein by a cache memory 40 and a BIOS boot read-only memory (ROM) 42. Of course, motherboard 34 can also include a math co-processor, additional memory, clock generator, power supply, and so forth as are generally well known to those skilled in the art.

Processing units 36, of which one is shown, interpret instructions and process data contained in computer applications. MMU 38 is a class of computer hardware components responsible for handling memory accesses requested by processing unit 36. MMU 38 functions in translation of virtual addresses to physical addresses (i.e., virtual memory management), memory protection, cache memory 40 control, bus arbitration, and so forth. Cache memory 40 can be thought of as a temporary storage area where frequently accessed data can be stored for rapid access, and BIOS boot ROM 42 refers to the software code stored in ROM that is run when computing system 30 is first powered on.

Computing system 30 further includes a hard drive 44 in communication with motherboard 34. Hard drive 44 serves as main storage for an operating system 46, separation management system 32, and user applications 48. It will be understood that hard drive 44 may be embodied as a single unit or multiple units.

Operating system 46 incorporates a code base 50, the collection of all source code for all of the code modules which make up operating system 46. Code base 50 includes, for example, OS vender code 52, third party code 54, and OS security critical data 56. A handler 58 is also associated with operating system 46. Handler 58 is a subroutine in operating system 46 that allows for handling of asynchronous hardware and software events using a generalized procedural interface. In accordance with the present invention (discussed below), “Events” may be generated by interrupts from software interrupt instructions, e.g., from OS vender code 52 and/or third party code 54 of operating system 46. Per convention, events may also include network interface cards requesting service, the clicking of a mouse, a clock or timer reaching some predetermined time, the dragging of a scroll bar within a windowing system, or the processing of a button on a key board.

A monitor 60 is included in computing system 30 for displaying graphics and text generated by software programs and program modules that are run by computing system 30. A graphics card 62 is interposed between motherboard 34 and monitor 58. Graphics card 62 is a circuit board containing a video processor 64, video memory (RAM) 66, and other electronics to provide a bitmap display (not shown) to monitor 60. Graphics card 62 may be optionally substituted for an integrated graphics chip on a section of motherboard 34.

A keyboard 68 is coupled to motherboard 34 for user entry of text and commands that affect the running of applications 48 executing on computing system 30. A mouse 70, or other pointing device, may be in communication with motherboard 34 such that signals from mouse 70 can be conveyed to motherboard 34 to control a cursor on monitor 60 and to select text, menu options, and graphic component displayed on monitor 60, as known to those skilled in the art.

Computing system 30 can further include peripherals that may be attached externally, typically through some form of computer bus. Exemplary peripherals shown herein include a printer 72, a modem 74, and a scanner 76. Computing system 30 can further include a compact disk-read only memory (CD-ROM) drive 78 into which a CD-ROM disk may be inserted so that executable files and data on the disk can be read for transfer into the memory and/or into storage on hard drive 44. Other storage devices, such as a digital versatile disc-read only memory (DVD-ROM) drive 80 and/or a floppy disk drive 82 may also or alternatively be included. The various components of computing system 30 are in communication with one another via conventional bus structures 84 known to those skilled in the art.

Many of the hardware components and peripheral devices that form computing system 30 are able to interact via device drivers, also known as software drivers. Device drivers typically form part of the lowest level (most privileged) level of operating system 46, i.e., the OS kernel, with which they are linked when the OS kernel is built. In this scenario, the device drivers can include OS vender code 50 and third party code 52. These device drivers may be trusted or untrusted. The term “trusted” refers to code that can be trusted more fully to follow its intended programming with a lower possibility of inappropriate activities occurring that are forbidden by its designers and other software writers. Conversely, the term “untrusted” denotes code from an unknown source that has not met predefined requirements to be trusted and may be potentially harmful to computing system 30. Third party code 54 may be “untrusted” even though it may be useful and completely benign because it has not been rigorously tested.

Separation management system 32 is executable code that employs the principle of least privilege as an overlay to underlying code base 50 of operating system 46 to govern interaction between various subsets of OS vender code 50 and third party code 52 without requiring modification to the existing code base 50.

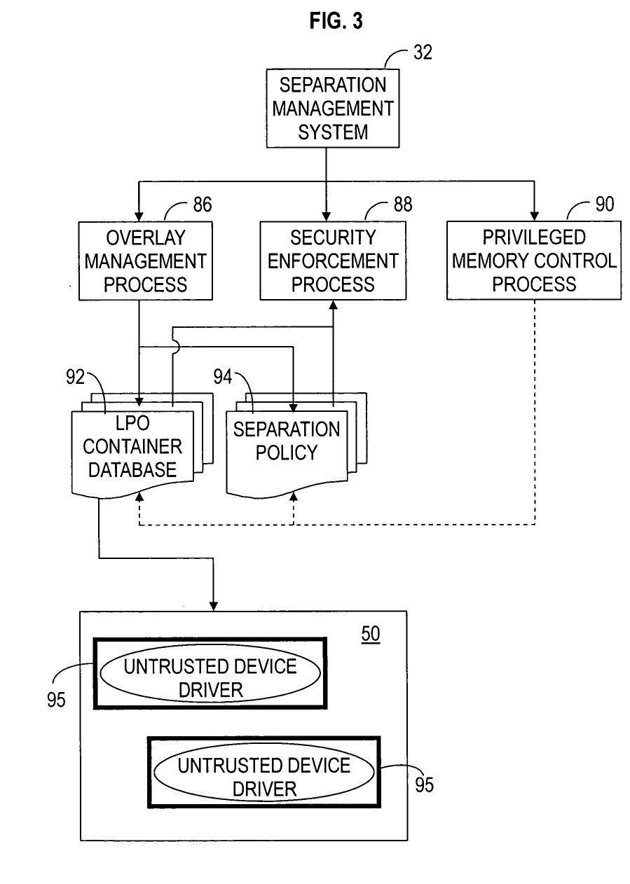

FIG. 3 shows a block diagram of separation management system 32. For purposes of the following discussion, separation management system 32 constitutes three components. Those components include an overlay management process 86, a security enforcement process 88, and a privileged memory control process 90. However, it should be understood that separation management system 32 need not be subdivided into three constituents.

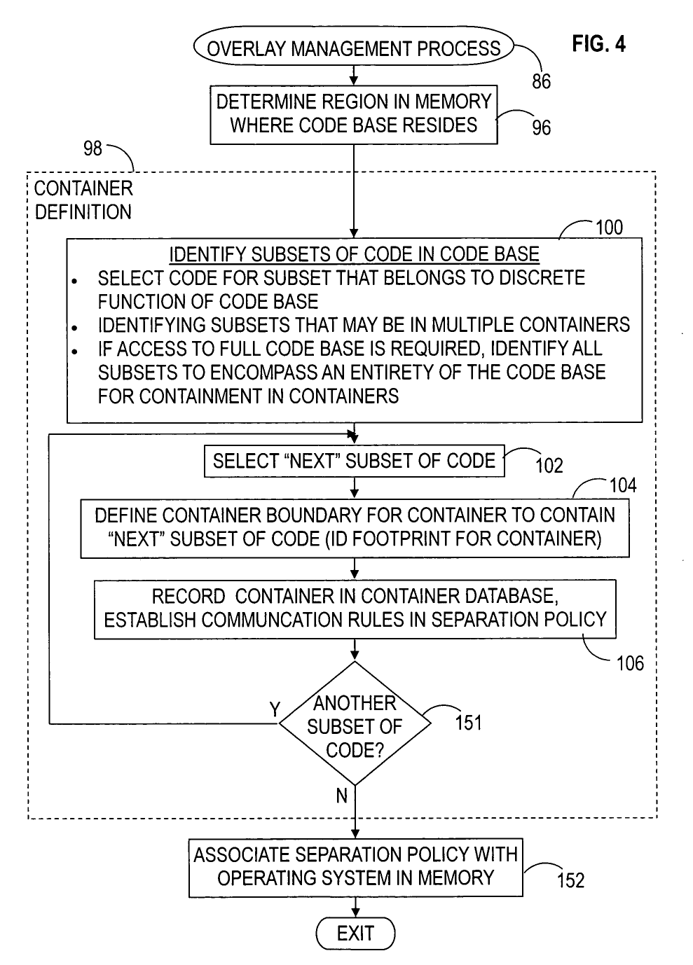

Overlay management process 86 is executed to define containers (discussed below) to partition particular subsets of code within code base 50 (FIG. 2) of operating system 46 (FIG. 2). Overlay management process 86 is discussed in connection with FIG. 4. The products of overlay management process 86 include a least privilege overlay (LPO) container database 92 and a separation policy 94, also discussed below.

In general, container database 92 defines the subsets of code within code base 50 that are isolated from the remaining code base 50. Subsets of code to be isolated from the remaining code base 50 reside in a plurality of containers 95 within code base 50. These containers 95 are specified within container database 92. Separation policy 94 sets forth the rules of allowable and disallowable interaction for each of the subsets of code within containers 95. It should be understood that container database 92 and separation policy 94 can take on a great variety of forms and/or the contents of each may be combined into a single, comprehensive database.

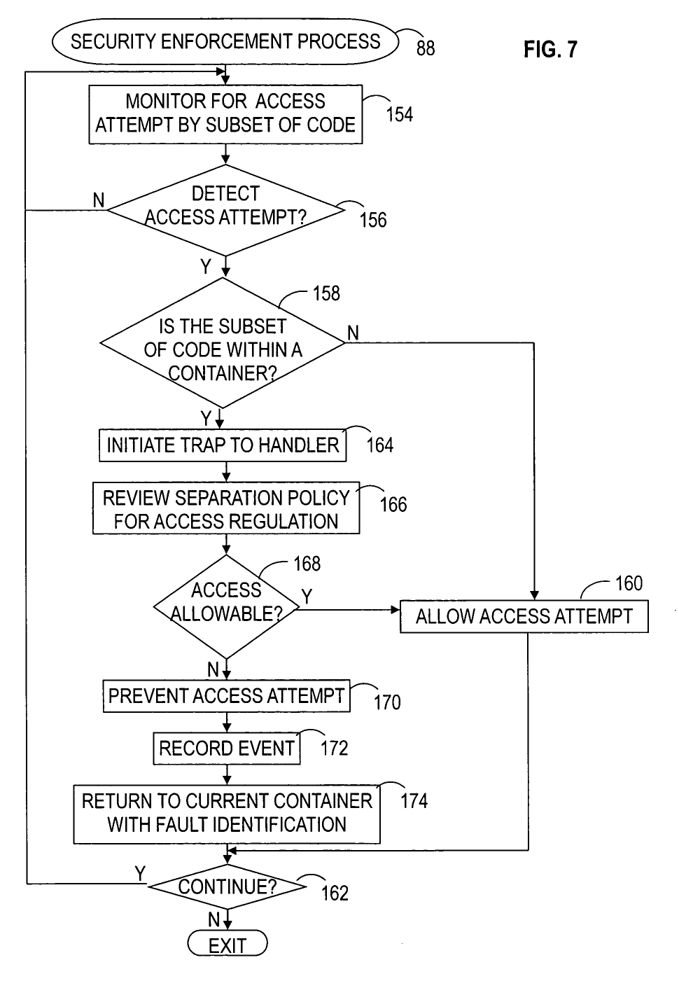

Security enforcement process 88 is executed in conjunction with operating system 46. Security enforcement process 88 utilizes the information within container database 92 and separation policy 94 to govern interaction and ensure separation of untrusted portions of code base 50 from the remainder of operating system 46 (FIG. 2). Thus, security enforcement process 88 is a policy manager. Security enforcement process 88 is discussed in connection with FIG. 7.

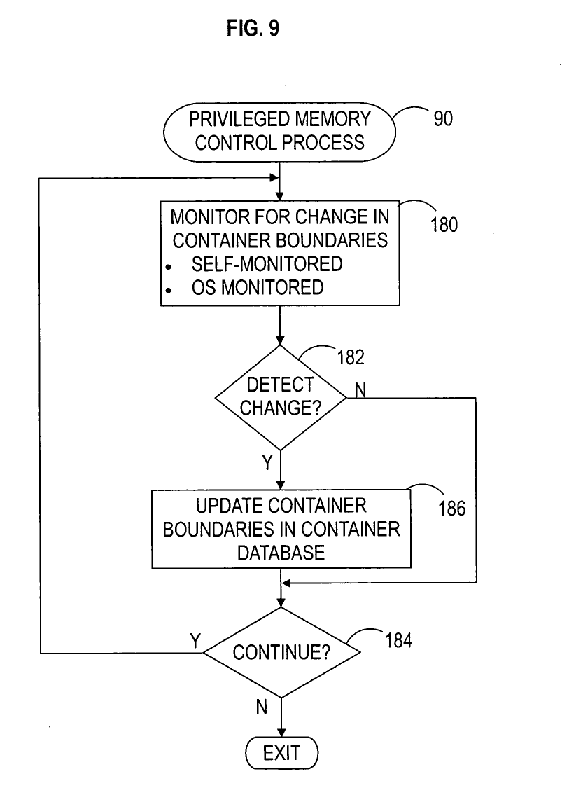

Privileged memory control process 90 works in conjunction with handler 58 (FIG. 2) to determine how boundaries of containers 95 defined in overlay management process 86 evolve over time, and updates those container boundaries as needed. Privileged memory control process 90 is discussed in connection with FIG. 9.

FIG. 4 shows a flowchart of an overlay management process 86. Overlay management process 86 is executed to define containers 95 (FIG. 3) to partition particular subsets of code within code base 50 (FIG. 2) of operating system 46 (FIG. 2). Overlay management process 86 may be executed when operating system 46 is built and/or during subsequent versions or updates of operating system 46. Thus, overlay management process 86 may be executed at a development platform by a developer/vendor of operating system 46.

The term “container” utilized herein refers broadly to “one that contains.” The present invention delineates “containers,” each of which is defined by container boundaries, in the form of memory addresses from a portion of memory in which code base 50 for operating system 46 resides. Each of the containers “contains” or encapsulates a subset of code within code base 50 of operating system 46.

Process 86 begins with a task 96. At task 96, a region in memory is determined where code base 50 (FIG. 2) is to reside. In this exemplary scenario, code base 50 is to reside on hard drive 44 (FIG. 2). Task 96 determines specifically where on hard drive 44, via appropriate memory addressing, that code base 50 is resides. It must be known where code base 50 is to reside in memory since the following methodology for setting up containers 95 (FIG. 3) relies on MMU 38 (FIG. 2).

A subsequent series of operations within overlay management process 86 forms a container definition subprocess 98 of process 86 to define containers 95 for specific subsets of code within code base 50.

Overlay management process 86 continues with a first task of container definition subprocess 98, specifically a task 100. At task 100, subsets of code within code base 50 and their specific regions within the memory allocated to code base 50 are identified. These subsets of code are those portions of OS vender code 52 (FIG. 2) and third party code 54 (FIG. 2) that the OS developer desires to isolate from the remainder of code base 50.

A number of guidelines can govern the selection of subsets of code. These guidelines include, for example, a) select code for a subset that belongs to a discrete function of code base 50; 2) identify subsets of code that may be in multiple containers; and 3) if access to full code base 50 is required, identify all subsets to encompass an entirety of code base 50 for containment in containers 95.

Regarding guideline a), ideally boundaries for containers 95 (FIG. 3) containing subsets of code within code base 50 should be chosen so that code and data that belong to a particular discrete function of code base 50, e.g. networking-related device drivers, reside in a single container 95. Defining container boundaries in this manner can yield security and performance benefits.

Regarding guideline b), in general, protections are strongest if container boundaries of containers 95 do not overlap. However, some programming models anticipate wide ranging access to a stack data structure which maintains execution state for code base 50 (FIG. 3). If this data structure is only available in a single one of containers 95 and is frequently used, it could be a bottleneck for computing system 30 performance. Accordingly, data structures and code which share these characteristics should be made natively available to containers 95 which frequently access them, i.e., this part of code base memory should be defined in multiple containers 95 which require frequent access to it.

Regarding guideline c), if access to the full code base 50 is required, the plurality of containers 95 must cover the entire code base 50. That is, each area of memory 44 in which code base 50 resides must be defined in at least one of containers 95. Those skilled in the art will recognize that an OS developer may adopt some or all of the aforementioned guidelines. In addition, an OS developer may adopt additional or alternative guidelines.

Following identification task 100, overlay management process 86 proceeds to a task 102. At task 102, a “next” one of the subsets of code identified at task 100 is selected. Of course, during a first iteration of task 102, the “next” subset of code is a “first” subset of code.

In response to task 102, a task 104 is performed. At task 104, container boundaries are defined for one of containers 95 (FIG. 3) to contain the “next” subset of code. It should be recalled that OS vender code 52 (FIG. 2) and third party code 54 (FIG. 2) resides in a portion of memory, i.e. a portion of hard drive 44 (FIG. 2). Thus, defining container boundaries for the “next” subset of code entails determining particular memory addresses that specify a region of the subset of code within the memory allocated to code base 50. This definition of container boundaries identifies a footprint, i.e. the amount of space the subset of code occupies in memory, for the particular one of containers 95.

Following task 104, a task 106 is performed to record the newly defined container 95 in LPO container database 92 (FIG. 3) and establish interaction rules within separation policy 94 (FIG. 3).

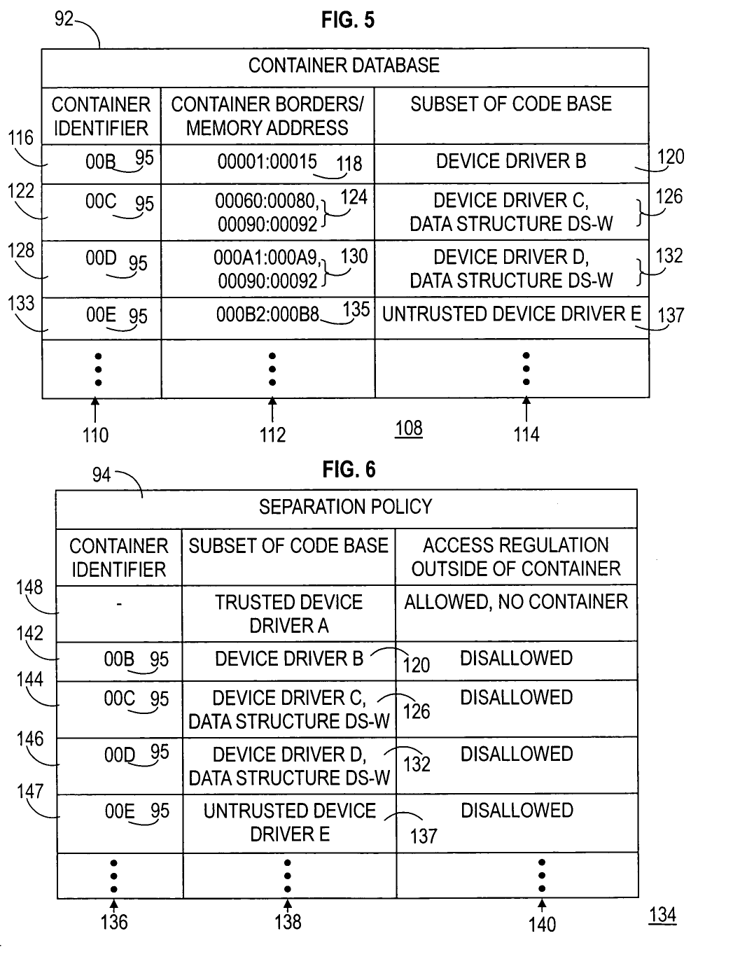

Referring to FIG. 5 in connection with task 106, FIG. 5 shows a table 108 representing LPO container database 92 defined in connection with execution of overlay management process 86. Table 108 includes exemplary information representative of what might be recorded in container database 92 in connection with task 106.

Table 108 includes a container identifier field 110, a container boundaries field 112, and a code field 114. Thus, a first entry 116 within database 92 reveals one of containers 95 identified by “00B” in container identifier field 110, first boundaries 118, in the form of a memory address in container boundaries field 112, as being “00001:00015,” and a first subset of code 120 within code base 50 (FIG. 2) contained within first boundaries 118 as being “Device Driver B,” as shown in code field 114.

Likewise, a second entry 122 within database 92 reveals one of containers 95 identified by “0° C.” in container identifier field 110, second boundaries 124, in the form of memory addresses in container boundaries field 112, as being “00060:00080” and “00090:00092,” and a second subset of code 126 within code base 50 (FIG. 2) contained within second boundaries 124 as being “Device Driver C” and “Data Structure DS-W,” as shown in code field 114. A third entry 128 within database 92 provides an example in which a particular subset of code, in this case “Data Structure DS-W” is contained within two of containers 95. That is, third entry 128 reveals one of containers 95 identified by “00D” in container identifier field 110, third boundaries 130, in the form of memory addresses in container boundaries field 112, as being “000A1:000A9” and “00090:00092.” A third subset of code 132 within code base 50 contained within third boundaries 130 as being “Device Driver D” and “Data Structure DS-W.” Thus, “Data Structure DS-W” has been made natively available to containers 95 of second and third entries 122 and 128, respectively.

A fourth entry 133 within database 92 reveals one of containers 95 identified by “00E” in container identifier field 110, fourth boundaries 135, in the form of a memory address in container boundaries field 112, as being “000B2:000B8,” and a fourth subset of code 137 within code base 50 (FIG. 2) contained within fourth boundaries 135 as being “Untrusted Device Driver E,” as shown in code field 114. Fourth subset of code 137 may be third party code 54 (FIG. 2) for which vigorous testing has not been performed and that does not require extensive access to the remainder of operating system 46 (FIG. 2).

Now referring to FIG. 6 in connection with task 106 of overlay management process 86 (FIG. 4), FIG. 6 shows a table 134 representing separation policy 94 created in connection with the execution of the overlay management process 86. Table 134 includes exemplary information representative of what might be recorded in separation policy 94 in connection with task 106.

Table 134 includes a container identifier field 136, a code field 138, and an access regulation field 140. Thus, a first entry 142 within separation policy 94 reveals one of containers 95 identified by “00B” in container identifier field 136, first subset of code 120 within code base 50 (FIG. 2) as shown in code field 138, an OS access regulation of “Disallowed” in regulation field 140. First entry 142 indicates that Device Driver B is disallowed from accessing the remainder of code base 50 (FIG. 2) outside of its corresponding first boundaries 118 (FIG. 5). This situation is the same for second, third, and fourth entries 144, 146, and 147. That is, second, third, and fourth subsets of code 126, 132, and 137, respectively, are disallowed from accessing the remainder of code base 50 (FIG. 2) outside of their associated second, third, and fourth boundaries 124, 130, and 135, respectively.

In contrast, a fifth representative entry 148 is shown herein to distinguish a fifth subset of code 150 within code base 50 (FIG. 2) that is not containerized. Fifth subset of code 150 is referred to as “Trusted Device Driver A, and is considered to be trusted. Therefore, Device Driver A need not be overlaid with container boundaries, and Device Driver A retains unmediated access to OS security critical data 56 (FIG. 2).

Fifth representative entry 148 is shown herein to illustrate a distinction between those subsets of code that are trusted and can have unmediated access to OS security critical data 56 and those subsets of code that have limited access to the remainder of code base 50, and particularly OS security critical data 56, in accordance with the present invention. However, it should be understood that subsets of code from code base 50 that are not overlaid with one of containers 95 need not necessarily be listed within separation policy 94. Rather, only those subsets of code from code base 50 that are subject to governed interaction within operating system 46 may be specified in separation policy 94.

Although separation policy 94 shows access regulation as being simply allowed or disallowed, separation policy 94 could include particular stipulations for allowed and/or disallowed access to the remainder of code base 50. In addition, it should be further understood that LPO container database 92 and separation policy 94 need not be separate records, but could instead be combined as a single database.

Referring back to FIG. 4, following recordation task 106, process control proceeds to a query task 151. At query task 151, a determination is made as to whether there is another subset of code identified at task 100 for which container boundaries need to be defined and recorded. When there is another subset of code, process 86 loops back to task 102 to select the “next” subset of code. However, when there are no further subsets of code, program control proceeds to a task 152.

At task 152, separation policy 94 and LPO container database 92 are associated with operating system 46 (FIG. 2) in memory, i.e., hard drive 44. Thus, as operating system 46 executes, process interaction will be governed in accordance with separation policy 94, as will be discussed in connection with FIG. 7. Following task 152, overlay management process 86 exits.

FIG. 7 shows flowchart of a security enforcement process 88. Security enforcement process 88 may be executed upon initialization of and in conjunction with operating system 46 (FIG. 2). Security enforcement process 88 utilizes the information within container database 92 and separation policy 94 to ensure separation of untrusted portions of code base 50 from the remainder of operating system 46. Thus, security enforcement process 88 may be executed at computing system 30 (FIG. 2).

Security enforcement process 88 begins with a task 154. At task 154, process 88 monitors for an access attempt by a subset of code within code base 50. In accordance with the present invention, an access attempt indicates an attempt to access code and/or data within code base 50, for example, other OS vendor code 52, third party code 54, and/or OS critical data 56 (FIG. 2), that is not part of the code that is currently executing within operating system 46 (FIG. 2).

A query task 156 is performed in connection with task 154. Query task 156 determines whether an access attempt is detected. When an access attempt is not detected, program control loops back to task 154 to continue monitoring for access attempts. However, when an access attempt is detected, process 88 proceeds to a query task 158.

At query task 158, a determination is made as to whether the currently executing subset of code resides within one of containers 95. When the subset of code does not reside within one of containers 95, process control proceeds to a task 160.

At task 160, the access attempt is allowed. That is, since the subset of code does not reside within one of containers 95, it has unmediated access to code base 50 (FIG. 2) within operating system 46 (FIG. 2). Following task 160, process 88 proceeds to a query task 162.

At query task 162, a determination is made as to whether security enforcement process 88 is to continue executing. Process 88 executes in conjunction with operating system 46. Thus, process 88 continues whenever operating system 46 is booted up, that is while computing system 30 (FIG. 2) is powered on. When process 88 is to be discontinued, process 88 exits. However, when process 88 is to continue, program control loops back to task 154 to continue monitoring for access attempts.

Referring back to query task 158, when the subset of code resides within one of containers 95, process control proceeds to a task 164. At task 164, process 88 initiates a trap to handler 58 (FIG. 2). As well known to those skilled in the art, a trap is a particular programming software routine designed to catch and control an exception condition. In this situation, the exception condition is an access attempt by a subset of code base 50 (FIG. 2) residing in one of containers 95 (FIG. 3).

In response to initiation of a trap at task 164, process 88 proceeds to a task 166. At task 166, handler 58 reviews separation policy 94 (FIG. 6) for access regulation to determine whether access is allowable or disallowable.

A query task 168 is performed in connection with task 166. At query task 168, a determination is made in response to review of separation policy 94 as to whether access is allowable. When the access attempt is allowable, process 88 proceeds to task 160. At task 160, handler 58 allows transition to the new code (i.e., the access attempt) and allows execution to proceed. However, when the access attempt is disallowable, process control proceeds to a task 170.

At task 170, handler 58 prevents the access attempt, i.e. disallows transition to the new code.

In response to task 170, a task 172 is performed. At task 172, the access attempt is recorded. By way of example, handler 58 may take a number of actions when it is invoked prior to completing the failure. For example, handler 58 may be designed to audit the event. This specific behavior of handler 58 can be based on the policy implemented by the designer of separation management system 32 (FIG. 2).

A task 174 is performed following task 172. At task 172, handler 58 returns to the current subset of code within the current one of containers 95 with a failure. For example, a general protection fault may be raised that indicates that the currently executing subset of code has violated the rules of separation policy 94.

Following task 174, process 88 proceeds to query task 162 to again determine whether the execution of process 88 is to continue and cause a loop back to monitoring task 154, or to discontinue and exit.

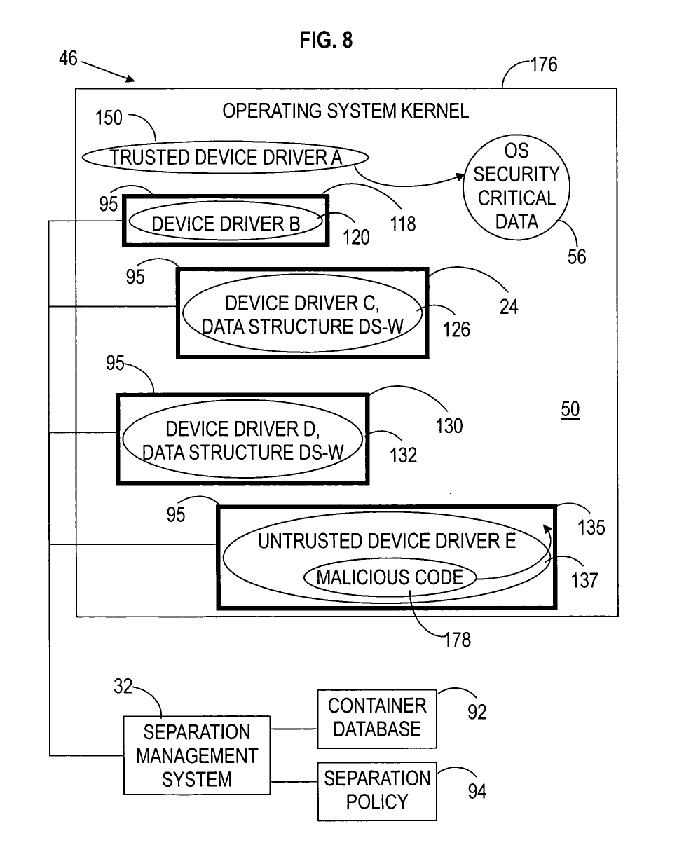

FIG. 8 shows an illustrative diagram of a kernel 176 of operating system 46 in which separation management system 32 has been implemented. As shown, separation management system 32 has been added outside the context of kernel 176 which has set up overlay boundaries, i.e., containers 95, on regions of physical memory that contain subsets of code base 46 which cannot be trusted.

Kernel 176 includes first, second, third, and fourth subsets of code 120, 126, 132, and 137 residing in containers 95 defined by container boundaries 118, 124, 130, and 135, respectively. Thus, interaction between any of first, second, third, and fourth subsets of code 120, 126, and 132, and 137 with any portion of code base 50 outside of their respective containers 95 is governed by the rules set forth in separation policy 94. However, fifth subset of code 150 does not reside within one of containers 95 and therefore retains unmediated access to code base 50.

Of particular interest, fourth subset of code 137 (Untrusted Device Driver E) has been infected by malicious code 178. Through the execution of security enforcement process 88 (FIG. 7), an access attempt by malicious code 178 embedded in fourth subset of code 137 is detected and prevented. Thus, malicious code 178 is unable to directly access OS security critical data 56 or any other portion of code base 46 residing outside of fourth boundaries 135.

FIG. 9 shows a flowchart of privileged memory control process 90. Privileged memory control process 90 works in conjunction with handler 58 (FIG. 2) to determine how boundaries of containers 95 defined in overlay management process 86 (FIG. 4) evolve over time, and updates those container boundaries as needed. Thus, privileged memory control process 90 may be executed at computing system 30 (FIG. 2).

Process 90 begins at a task 180. At task 180, process 90 monitors for a change in container boundaries 180. In general, the boundaries of containers 95 (FIG. 3) are static in nature. However, it is common for areas of memory to be allocated and deallocated from different processes over time. Thus at task 180, process 90 monitors for these changes, i.e. allocation and/or deallocation of regions of memory. This monitoring may be self-monitored. Self-monitoring may occur in conjunction with information provided by handler 58 or process 90 may access data structures of code base 50 (FIG. 2) for hints that will improve its operation in this area, i.e. indicate changes in boundaries.

Typically, operating system 46 has no awareness of containers 95 defined by separation management system 32. However, in an alternative embodiment, monitoring at task 180 may be performed by operating system 46 itself. For example, the underlying code base 50, especially kernel 176 (FIG. 8), may be modified to be aware of and take advantage of security management system 32 so as to improve the performance of system 32. In the alternative embodiment, in the case of dynamic boundaries, instead of process 90 monitoring for changes in the boundaries, operating system 46 may be modified to monitor for changes in the boundaries and inform process 90 of those changes.

In either instance, a query task 182 is performed in connection with task 180. At query task 182, a determination is made as to whether a change in any container boundaries is detected. When no change is detected, process 90 proceeds to a query task 184.

Query task 184 determines whether monitoring is to continue. This continuation may coincide with the continued execution of operating system 46. When process 90 is to be discontinued, privileged memory control process exits. However, when the execution of process 90 is to continue, program control loops back to monitoring task 180.

Referring back to query task 182, when a change in any container boundaries is detected, process 90 proceeds to a task 186. At task 186, container boundaries (i.e. memory addresses) are updated in container boundaries field 112 of LPO container database 92 (FIG. 5). That is, memory addresses defining one of container boundaries may be changed from a first memory address to a second memory address. Following task 186, process 90 again proceeds to query task 184 to determine whether execution is to continue or exit.

In summary, the present invention teaches of methodology and a separation management system for governing interaction between subsets of code within a code base of, for example, an operating system. In particular, container boundaries are defined for containers (i.e., areas of memory) in which subsets of code reside that cannot be trusted. A separation policy governs the allowability of these containerized subsets of code to interact with other code or operating system security critical data within the operating system. The methodology and system serve as a least privilege overlay technique for an operating system so as to not adversely affect the performance of the operating system. Moreover, isolation and security protections can be applied to code without modifying the code itself. Since no modification to the operating system is required, the least privilege overlay technique can be readily implemented with and provide improved security to legacy code. Thus, implementation of the methodology and separation management system permits the use of existing commercial off the shelf device drivers to be used in trusted applications.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A method for governing interaction between code within a code base operable on a computer comprising:
determining a region in a memory of said computer in which said code base resides;
defining container boundaries in said region for a plurality of containers, said containers containing subsets of said code;
creating a policy that governs said interaction between said subsets of said code contained in said containers; and
executing said operating system on said computer in accordance with said policy.

2. A method as claimed in claim 1 wherein said defining operation defines said containers to encompass an entirety of said code base.

3. A method as claimed in claim 1 wherein said defining operation comprises identifying unique footprints in said region of said memory for each of said containers.

4. A method as claimed in claim 3 wherein each of said unique footprints is non-overlapping.

5. A method as claimed in claim 1 wherein said defining operation comprises identifying said container boundaries such that a first subset of said code is included in two of said containers.

6. A method as claimed in claim 1 wherein said defining operation comprises selecting said code for a first subset of said code that belongs to a discrete function of said code base.

7. A method as claimed in claim 1 wherein said defining operation comprises specifying memory addresses for each of said containers within said region of said memory, said memory addresses establishing said container boundaries.

8. A method as claimed in claim 7 further comprising:
determining a change of one of said memory addresses defining said container boundaries for a first one of said plurality of containers; and
specifying a second memory address for said first container within said region.

9. A method as claimed in claim 8 wherein said determining operation comprises monitoring said change of said one of said memory addresses via said code base.

10. A method as claimed in claim 1 wherein said executing operation comprises preventing a first one of said subsets of said code within a first one of said containers from access to said code outside of said first container when said access is disallowable as indicated by said policy.

11. A method as claimed in claim 1 further comprising:
detecting, in response to said executing operation, an attempt by a first one of said subsets of said code within a first one of said containers to access said code outside of said first container; and
initiating a trap to a handler of said code base in response to said detecting operation, said handler performing one of allowing said access to said code outside of said first container and preventing said access to said code outside of said first container in accordance with said policy.

12. A method as claimed in claim 1 further comprising:
detecting, in response to said executing operation, an attempt by a first one of said subsets of said code within a first one of said containers to access said code outside of said first container; and
raising a fault identifier when said access is disallowed as indicated by said policy.

13. A method as claimed in claim 1 further comprising recording an event when a first one of said subsets of said code within a first one of said containers attempts to access said code outside of said first container.

14. A method as claimed in claim 1 further comprising identifying untrusted code within said code base for separation within each of said plurality of containers.

15. A method as claimed in claim 1 wherein said code base comprises source code for an operating system.

16. A computer-implemented separation management system executable in connection with an operating system of a computer for providing separation between code within a code base of said operating system, said system comprising:
a plurality of containers established in a region of a memory of said computer in which said code base resides, said containers being defined by container boundaries, and said containers containing subsets of said code within said code base, said subsets of said code being untrusted code within said operating system;
a policy that governs interaction between said subsets of said code contained in said containers; and
a policy manager executed in connection with said operating system on said computer, said policy manager utilizing said policy to govern interaction between said subsets of said code.

17. A system as claimed in claim 16 wherein said plurality of containers encompasses an entire footprint of said region of said memory.

18. A system as claimed in claim 16 wherein said container boundaries comprise memory addresses within said region of said memory.

19. A system as claimed in claim 16 wherein said policy manager prevents a first one of said subsets of said code within a first one of said containers from access to said code outside of said first container when access is disallowable as indicated by said policy, and said first subset of said code is permitted said access when said access is allowable as indicated by said policy.

20. A system as claimed in claim 16 wherein said separation manager enables initiation of a trap to a handler of said operating system when a first one of said subsets of said code within a first one of said containers attempts to access said code outside of said first container, said handler performing one of allowing said access to said code outside of said first container and preventing said access to said code in accordance with said policy.

21. A method for governing interaction between code within a code base operable on a computer comprising:
determining a region in a memory of said computer in which said code base resides;
defining container boundaries in said region for a plurality of containers, said containers containing subsets of said code, and said defining operation including:
identifying unique footprints in said region of said memory for each of said containers; and
selecting said code for a first one of said subsets of said code that belongs to a discrete function of said code base;
creating a policy that governs interaction between said subsets of said code contained in said containers;
executing said code base on said computer in accordance with said policy such that each of said subsets of said code is prevented from access to said code outside of an associated one of said plurality of containers when said access is disallowable as indicated by said policy.

22. A method as claimed in claim 21 wherein said defining operation further includes defining said containers to encompass an entire footprint of said region of said memory.

23. A method as claimed in claim 21 wherein said defining operation further comprises identifying said container boundaries for a second one of said subsets of said code such that said second subset of said code is included in two of said containers.
